(19) United States
(12) Patent Application Publication
(10) Pub. No.: US 2012/0101970 A1
(43) Pub. Date: Apr. 26, 2012

(54) METHOD AND SYSTEM OF MONITORING A NETWORK BASED COMMUNICATION AMONG USERS

(75) Inventors: Dror Zernik, Tel-Aviv (IL); Hanan Lavy, Tel-Aviv (IL)

(73) Assignee: United Parents Online Ltd., Tel-Aviv (IL)

(21) Appl. No.: 13/380,078

(22) PCT Filed: Jun. 22, 2010
(86) PCT No.: PCT/IL10/00495

§ 371 Date: Dec. 22, 2011

Related U.S. Application Data
(63) Continuation of application No. 12/534,129, filed on Aug. 2, 2009.
(60) Provisional application No. 61/218,998, filed on Jun. 22, 2009.
(60) Provisional application No. 61/305,557, filed on Feb. 18, 2010.

(30) Foreign Application Priority Data
Jan. 26, 2010 (IB) PCT/IB2010/050329

(51) Int. Cl. G06N 5/00

(52) U.S. Cl. 706/45

(57) ABSTRACT

A method of classifying an examined user monitoring communication in at least one virtual environment. The method comprises providing a plurality of multisessions each held in a plurality of occasions between the examined user and another one of plurality of users, indentifying at least one communication pattern of the examined user by contextual data extracted from the plurality of multisessions, classifying at least one of said plurality of multisessions and the examined user according to the at least one communication pattern, and outputting a notification indicative of said classification.

### RELATED APPLICATIONS

This application claims priority from U.S. Provisional Patent Application No. 61/305,557, filed on Feb. 18, 2010; International Patent Application PCT/IB2010/050329 filed 26 Jan. 2010; U.S. patent application Ser. No. 12/534,129 filed on 2 Aug. 2009; and U.S. Patent Application No. 61/218,998, filed on Jun. 22, 2009, which is incorporated herein by reference

The contents of all of the above documents are incorporated by reference as if fully set forth herein.

### FIELD AND BACKGROUND OF THE INVENTION

The present invention, in some embodiments thereof, relates to detection and/or monitoring methods and systems and, more particularly, but not exclusively, to network-based detection and/or monitoring methods and systems capable of identifying a malicious behavior of users, such as pre-defined criminological behaviors, in virtual environment.

Participating in virtual environments, such as social networking sites and using network based communication modules, such as Skype and Windows Messenger™ and online virtual communities, such as chat rooms and blogs, has become a daily habit for adults and children in the last few years. Social networking sites, such as MySpace.com and Facebook.com, Kidswril.com and imbee.com and various massively multiplayer online role playing games (MMORPG) such as, including Second Life, World of Warcraft, and RuneScape, allow users to chat, share a video conference call, post data and view messages and/or share personal information. This usually allows a person to communicate with other persons who have common backgrounds and/or who share common interests.

Currently popular virtual games and communities allow participants to interact via on-screen avatars, texting, and voice calls. In these networks, basic personal information about individuals may be obtained fairly readily, for example according to their membership in particular groups and/or identification photo.

Many of these virtual environments have policies requiring participants to disclose their age, and the communities either deny access to minors or limit their access to certain features of the community. However, it is difficult to ensure that participants are in fact the age they claim to be, especially in chat room and in environments where people often endow their avatars with characteristics quite different than those of the players themselves. As some virtual environments are used by children, they are often used by online predators and exploiters, such as pedophiles and offenders seeking to communicate with minor children for felonious reasons. Pedophiles are a significant problem for online communities, and many online communities take measures to detect and/or prevent pedophiles from interacting with children. As used herein a pedophile means a person or entity seeking inappropriate and/or illegal contact or communication with children, even if the communications are not sexual in nature and/or the person or entity does not meet a clinical definition of a pedophile.

Some online communities employ staffs who monitor ongoing communication in the virtual environment to look for inappropriate conversations.

Some monitoring methods and systems have been developed in the last years. For example, U.S Patent Application Publication No. 2009/0182872, published on Jul. 16, 2009 describes a method of detecting events in a computer-implemented online community includes providing a computer-implemented event processor, providing the computer-implemented event processor with a description of at least one event to he detected, automatically analyzing messages of the online community with the computer-implemented event processor to detect the at least one event, and issuing a notification of a detected event.

Another example is described in U.S Patent Application Publication No. 2009/0119242, published on May 7, 2009 which describes a method of detecting content communicated via a network is provided consisting of the steps of: classifying the content into a first category and a second category by means of a classification process; detecting one or more behavior parameters of a user accessing the content, where the communication patterns are associated with the content either consisting of first category content or second category content; and further classifying the content into first category content and second category content based on the behavior parameters detected for the user. The first category content generally consists of restricted or illegal content, and the second category content generally consists of unrestricted or legal content. The classification process consists of a pattern recognition technique that includes a training phase and a testing phase. The training phase provides statistical properties of a plurality of data objects which are labeled prior to testing as either restricted or unrestricted. The testing phase determines whether one or more data objects of content communicated via the network constitute restricted content or unrestricted content. A related system, network apparatus and computer program is provided.

### SUMMARY OF THE INVENTION

According to some embodiments of the present invention, there is provided a method of monitoring communication in at least one virtual environment. The method comprises providing a plurality of multisessions each held in a plurality of occasions between the examined user and another one of plurality of users, indentifying at least one communication pattern of the examined user by contextual data extracted from the plurality of multisessions, classifying at least one of the plurality of multisessions and the examined user according to the at least one communication pattern, and outputting a notification indicative of the classification.

Optionally, the identifying comprises analyzing the plurality of multisessions to identify a plurality of communication characteristics and indentifying the at least one communication pattern according to a combination of the plurality of communication characteristics.

Optionally, the contextual data comprises a number of rejections of communication trails of the examined user by one of the plurality of users.

Optionally, the contextual data comprises a dataset mapping relationships among the plurality of users and the indentifying the at least one communication pattern according to the dataset.

Optionally, the identifying comprising identifying a progress in pre-defined criminological communication scenario in at least two of the plurality of multisessions;

the indentifying being performed according to the progress.

Optionally, the identifying comprising identifying at least one of a presence and an absence of a common characteristic among the plurality of users; the indentifying being performed according to at least one of the presence and the absence.

Optionally, the identifying comprising identifying a type of a relationship between the examined user and the one of the plurality of users in at least two of the plurality of multisessions and the indentifying the at least one communication pattern by matching the types.

Optionally, the identifying comprising matching a first user profile of the examined user with a second user profile of a previously classified examined user and the indentifying the at least one communication pattern according to the match.

Optionally, the analyzing contextual data comprises a plurality of contextual communication characteristics of the plurality of multisessions.

Optionally, the indentifying comprising combining a first output of contextual analysis of the plurality of multisessions with a second output of a content analysis of the plurality of multisessions.

Optionally, the indentifying comprising detecting usage in one or more proxy servers by the examined user; the indentifying being performed according to the usage.

Optionally, the identifying is performed without a content analysis of the plurality of multisessions.

Optionally, the providing comprises monitoring the plurality of multisessions in real time; wherein the outputting is performed in real time.

Optionally, the providing comprises monitoring at least one virtual environment to document the plurality of multisessions.

Optionally, the at least one communication pattern is a safe activity indicative communication pattern.

Optionally, the at least one communication pattern is a threat indicative communication pattern, the outputting comprises alarming a member of a group consisting of: at least one guardian associated with at least one of the plurality of users, an administrator of the at least one virtual environment, and at least one of the plurality of users.

Optionally, the at least one communication pattern is a risk taking communication pattern, the outputting comprises a member of a group consisting of: alarming at least one guardian associated with the examined user and presenting a feedback to the examined user.

According to some embodiments of the present invention, there is provided a system of monitoring communication in at least one virtual environment. The system comprises a repository which stores a plurality of multisessions each held in a plurality of occasions between the examined user and another one of plurality of users, an analysis unit which analyzes the plurality of multisessions to identify at least one communication pattern and classifies at least one of the plurality of multisessions and the examined user according to the at least one communication pattern, and an output unit which outputs a notification pertaining to the classification.

Optionally, the system further comprises a monitoring unit which monitors the at least one virtual environment to document the plurality of multisessions in the repository.

According to some embodiments of the present invention, there is provided a method of providing a feedback to a user communicating in at least one virtual environment. The method comprises monitoring a plurality of multisessions each held in a plurality of occasions between an examined user and a plurality of users of the at least one virtual environment, identifying at least one risk avoidance communication pattern of the examined user according to an analysis of the plurality of multisessions, and outputting a positive feedback in response to the identification.

Optionally, the outputting comprises presenting the positive feedback to the examined user in real time.

Optionally, the outputting comprises sending the positive feedback to a guardian of the examined user in real time.

According to some embodiments of the present invention, there is provided a method of classifying a plurality of examined users in at least one virtual environment. The method comprises monitoring a plurality of multisessions each held in a plurality of occasions between at least two of plurality of examined users of the at least one virtual environment, indentifying at least one safe activity indicative communication pattern of a first group of the plurality of examined users and indentifying at least one threat indicative communication pattern of a second group of the plurality of examined users, classifying at least one member of the first and second groups according to the identification, and outputting a notification indicative of the classification.

Optionally, the identifying is performed by combining data extracted from the plurality of multisessions.

According to some embodiments of the present invention, there is provided a method of providing a feedback to a user communicating in at least one virtual environment. The method comprises monitoring a plurality of multisessions each held in a plurality of occasions a plurality of examined users of the at least one virtual environment, identifying at least one of a safe activity indicative communication pattern and a threat indicative communication pattern by an analysis of the plurality of multisessions, tagging at least some examined users as potentially malicious according to the identification, and outputting a feedback for a communication with at least one of the at least some examined users according to the tagging.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system of analyzing communication patterns of users in one or more virtual environments by an analysis of a plurality of multisessions, according to some embodiments of the present invention

FIG. 2 is a schematic illustration of an exemplary graph mapping relations between exemplary users, according to some embodiment of the present invention;

FIG. 3 is an exemplary method of classifying an examined user or multisessions thereof according to safe activity and/or threat indicative communication patterns which are identified in a plurality of multisessions with a plurality of different users, according to some embodiments of the present invention; and

FIG. 4 is a flowchart of method of classifying the risk affinity of users and/or providing a positive and/or negative feedback to a user pertaining to a communication in a virtual environment, according to some embodiments of the present invention.

### DESCRIPTION OF EMBODIMENTS OF THE INVENTION

The present invention, in some embodiments thereof, relates to detection and/or monitoring methods and systems and, more particularly, but not exclusively, to network-based detection and/or monitoring methods and systems capable of identifying a systematic felonious behavior, such as pedophilic behavior, in virtual environments.

According to some embodiments of the present invention provided are methods and systems of classifying users and/or multisessions thereof, in one or more virtual environments, according to patterns exhibited in communication with other users. The identified patterns may be threat indicative communication patterns, such as pre-defined criminological patterns, for example pedophilic patterns, safe activity communication patterns, such as child communication patterns, risk avoiding communication patterns and/or risk taking communication patterns. For each examined user, a plurality of multisessions, each held in a plurality of occasions between the examined user and another of a plurality of users of the one or more virtual environments are provided, for example monitored and documented. Now, a contextual analysis which combines data from these multisessions allows indentifying one or more communication patterns of the examined user. Additionally or alternatively, a content analysis which combines data from these multisessions is also performed. This allows classifying, which may be used to describe any weighing, clustering, and/or tagging, the examined user and/or multisessions thereof according to the communication patterns, for example a malicious user and/or multisession, a risk taking user and/or multisession that indicates that the examined user takes high risks, risk avoiding user and/or a safe user and/or multisession. A notification which is based on the classification may now be outputted, for example an alarm message which is sent to the users the examined user interacts within the multisessions, a notification to the guardians of the users, and/or to the system operator and/or a system module. Optionally, the alarming is performed according to an analysis of the metadata related to the classified multisessions and/or interacted users. Optionally, data of multisessions of an examined user from a plurality of virtual environments and/or under a plurality of different identity are combined for classifying the examined user. The combination is based on fingerprinting methods that allows identifying different identities as related to a common examined user.

According to some embodiments of the present invention there are provided methods and systems of classifying users and/or multisessions of a virtual environment based on safe activity communication patterns and threat activity communication patterns. In such an embodiment, not only threat indicative communication patterns are assessed but also safe activity communication patterns can be used to reduce false positive alerts and/or tagging.

According to some embodiments of the present invention there are provided methods and systems of providing a feedback to the communication behavior of a user in one or more virtual environments. The method, for example, is based on monitoring a plurality of multisessions each held in a plurality of occasions between an examined user and a plurality of users of the virtual environments. This allows identifying one or more risk avoidance communication patterns of the examined user according to an analysis of the plurality of multisessions and outputting a positive feedback to the examined user in response to the identification. The positive feedback may also be provided when a user, such as a child breaks off an escalating contact with a malicious user, such as a suspected pedophile.

According to other embodiments of the presenting invention there are provided methods and systems for providing positive and/or negative feedbacks to users according to the users they communicate with. In such an embodiment, a positive feedback that encourages the user to adopt certain communication patterns and/or a negative feedback that discourages the user to adopt other communication patterns is generated and provided to an examined user, optionally in real time. Optionally, the feedback is generated based on a preprocessing procedure in which the users of one or more virtual environments are tagged, for example as malicious or safe users. The tagging allows identifying when the user communicates with a malicious users, what is the frequency in which the user communicates with malicious users, thus the user rejects malicious users and the like. Known systems usually assume that since it is highly desired to issue alerts as soon as possible, it is vital to issue this alert immediately when identified. This implies that there is no room for letting the protected user overcome threats by him. In contrast, the positive and optionally negative feedback allows for issuing a notification which is indicative on avoided threats to the child or to his guardian(s). This allows educating monitored users for better and safer communication patterns and/or to prevent from malicious relationships to mature in a manner that risks the monitored users.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

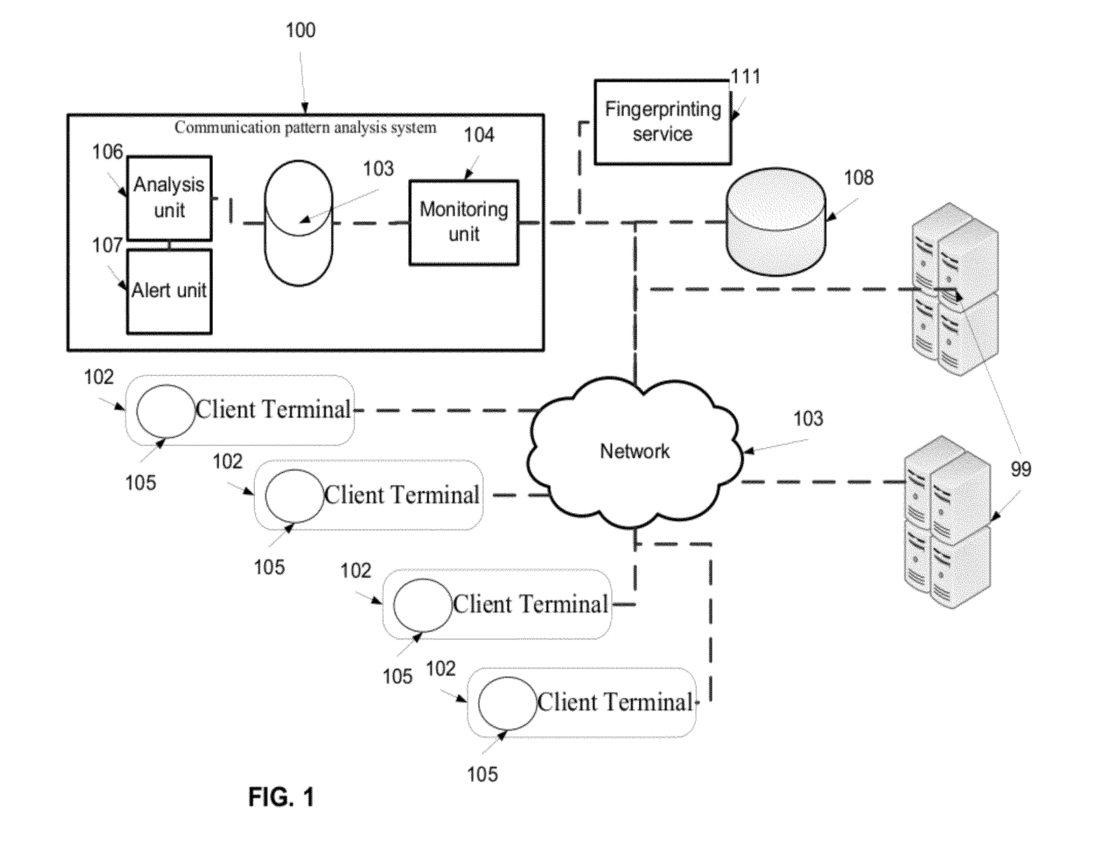

Reference is now made to FIG. 1, which is a schematic illustration of a system 100 of analyzing communication patterns of users in one or more virtual environments by an analysis of a plurality of multisessions, according to some embodiments. As used herein a virtual environment means a social networking site, an online multiplayer game, for example a role playing game, a chat room, a site providing a chat room, an instant messaging service, a subscriber based communication service, and/or any environment in which a plurality of client terminals 101 allow a plurality of users (not shown) to communicate with one another, via texting, chatting, talking, and/or exchanging messages. Further, any combination of these communication methods may form a virtual environment. As used herein, a multisession means an interaction which takes place on multiple occasions, in one or more virtual environments, or in a combination of such virtual environments, between the same two users. Each communication occasion may be a texting, chatting, messaging, emailing, and/or video conferencing, and/or audio conferencing session. For example, a multisession between user A and user B may be a record that includes some or all of the communication events between them in one or more virtual environments, such as Facebook™, Second Life and/or Skype™, during a period.

The communication pattern analysis system 100 is optionally implemented using one or more computing units, such as one or more application servers, which are connected to one or more networks 103, such as the internet. The communication pattern analysis system 100 may analyze the multisessions which are held among users who communicate using any client terminal 102 which is connected to the network 103. The client terminal 102 may be a laptop, a Smartphone, a cellular phone, a tablet, a personal computer a personal digital assistance (PDA) and the like.

Optionally, the system 100 includes a monitoring unit 104 which monitors a plurality of multisessions among a plurality of users. Optionally, if the monitored multisessions are held verbally a speech to text module may be used to allow content analysis. Additionally or alternatively, solely the contextual data of verbal and/or textual multisessions may be monitored. The monitoring unit 104 may be connected, optionally directly, to one or more the servers 99 of one or more virtual environments and/or set to receive related logs of data therefrom. Additionally or alternatively, monitoring modules 105, such as add-ons, are installed in the client terminals 102 and forwarding the content of the multisessions, optionally in real time and/or in a periodic log, to the monitoring unit 104. For example, such add-ons may be installed in a messaging service module and/or a browser installed in the client terminal 102, an independent module which identifies text inputted by a user, and/or a web based application which is loaded when the user access a certain address, for example as an active server page (ASP) application or an ASP.NET application may also be used.

The system 100 further includes a repository 103, or connected to an external repository, such as a database which hosts records of some or all of the multisessions, multisession logs and/or other data files which document the multisessions.

The system 100 further includes an analysis unit 106 which classifies the activity and/or multisessions of one or more examined users, for example some or all of the subscribers of a social networking site, each according to an analysis of his multisessions with interacted users. As used herein an examined user may be a participant of any virtual environment. The examined user may optionally have an identity of a user that operates under different usernames in one or more virtual environments. In such an embodiment, a fingerprinting service 111 may be used to combine different user names to a common examined user. As used herein, an interacted user is a user in contact with the examined user, for example participant's buddy of any virtual environment, and/or any virtual figure with which the examined user interacts and exchanges some communication.

Optionally, the classification is done on multisessions. The multisessions may be received from a logging service of the virtual environments 99, modules 105 installed in the client terminals 102 of the users, and/or from a intermediator that monitors multisessions which are conducted via peer to peer connection, for example upon request of one of the peer to peer users, as a service of the peer to peer communication service, and/or as a service provided by the internet service provider (ISP) of one of the users. For example multisessions between user A and user B are marked as high risk multisessions, where A imposes a threat to B. Based on this classification, both A and B classifications may be updated.

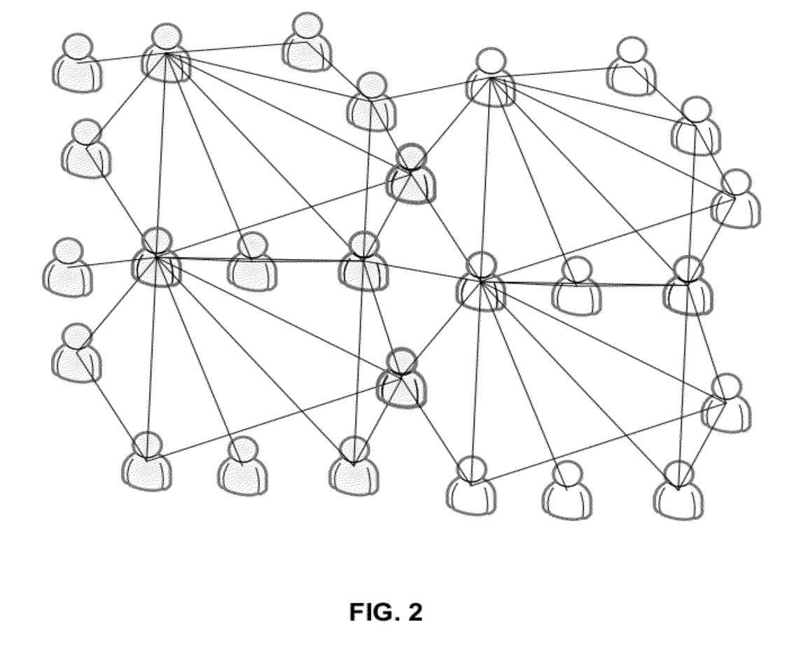

Optionally, the system 100 includes a user profile database 108 which stores one or more datasets for mapping some or all of the relations between all of the users. For example, FIG. 2 depicts an exemplary graph mapping relations between exemplary users. The datasets may be graphs, tables, indexes and/or any datasets that maps relations between all of the users. The dataset may be provided from an external source, such as the virtual environments or independently generated, optionally using the fingerprinting 111 service. In such a manner, the multisession pertaining to a certain examined user and the relationship among the interacted users can easily be found, for example as described below. Optionally, the user profile database 108 stores user information, such as contact details, for example an email address, a guardian contact detail, and/or a relevant enforcement agent. Optionally, the user information includes a set of user characteristics, for example age, gender, and/or any demographic data pertaining thereto. The user information may be provided during the subscribing to an alerting service provided by the system operator, the subscribing to one or more of the networking sites and/or games, and/or automatically gathered by identification and/or authentication processes. Optionally, the user profile database 108 is connected to an identity management module which tracks identities, for example using a fingerprint which is based on one or more parameters of a client terminal used during the multisessions, for example a media access control (MAC) address, the IP address and other parameters which uniquely identify the user with high probability such as some or all of the software versions installed on the device and some or all of the graphical properties of the device, or the phone number of the device. Optionally, the fingerprinting data is gathered by injecting an add-on such as a Java script, a Flash element, and/or an ActiveX element during an interaction with the virtual environment and/or a user monitored by the system 100, for example during a chat and/or by an email. Given a uniquely identifying fingerprint, multiple virtual identities can be aggregated into a single identity. In such a case, of fingerprint matching, all of the multisessions of the gathered identities are handled as multisessions of a single user.

In use, the analysis module 106 analyzes the multisessions of a certain examined user with a plurality of other users. This allows classifying the examined user or his multisessions according to threat imposed by him or her and optionally alerting users who interact therewith and/or their guardians, the authorities, and/or a virtual environment operator. Alternatively or additionally, the analysis of the analysis module 106 allows classifying the risk affinity of the examined user according to multisessions he or she participates in, for example as further described below. In such a manner, the examined user, or his or her guardians may be alerted regarding his tendency to take or to avoid risks.

In an exemplary embodiment of the invention, the classification of the examined user and/or his and/or multisessions is based on communication, contextual pattern analysis, for example as described below. In use, communication patterns, such as threat indicative communication patterns, safe activity indicative communication patterns, risk avoiding communication patterns and/or risk taking communication patterns, of the examined user are identified by analyzing a plurality of multisessions. Optionally, the examined user or his and/or multisessions may be classified according to a combination of a number of communication patterns, for example as described below. The classification allows detecting and classifying an examined user which exhibit one or more pedophilic communication patterns based on their communication with a plurality of children. As the analysis combines various multisessions and not based on the analysis of a single interaction or a number of interactions with the same child, serial or systematic patterns which cannot be detected by content analysis may be exposed.

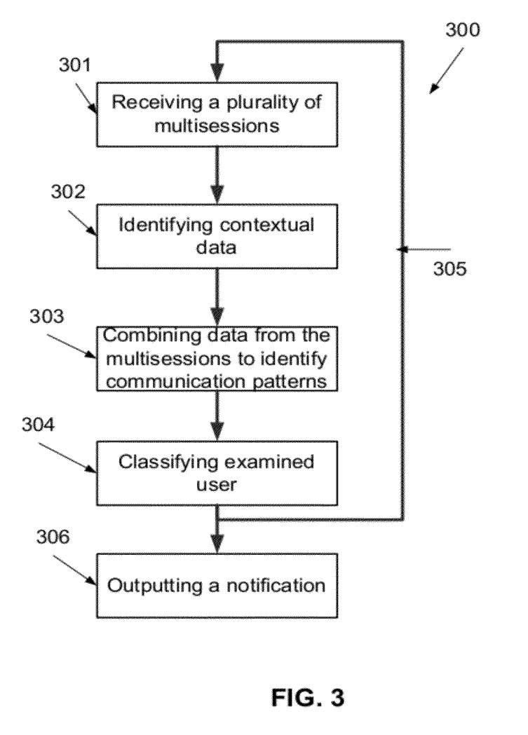

The system 100 may include or connected to an alert unit 107 which is set to alert one or more guardians, interacted users, law enforcement agents, such as the police, a system operator, and/or a system module according to the outputs of the analysis module 106. Exemplary functioning of the alert unit 107 is described below in relation to numeral 304 of FIG. 3.

Optionally, the monitoring unit 104 receives full or partial multisession scripts from modules installed in the client terminals 102. Optionally, the monitoring unit 104 includes or connected to recordings of communication scripts. It should be noted that gathering the textual and/or verbal content is optional and the analysis may be a contextual analysis that is not based on any of the content of the multisession but rather on the context in which the multisession is held, for example contextual data about the users, contextual data about the actual conducted multisessions, such as the duration of its occasions, the timing of its occasions, and the frequency of occasions (interactions), contextual data about the popularity of the users, such as the number and/or percentage of communication rejections, for example friendship request rejections, the number and/or percentage of communication acceptances, and/or contextual data which describe common characteristics of different multisessions and/or the relationship between the multisessions and a certain group, such as the similarity to other multisessions held by the examined user, the relationship among interacted users, and the like, together or separately, referred to herein as contextual data or meta-data. In such an embodiment, the system 100 may alert guardians and/or users without content analysis and/or full or even partial chat scripts.

Reference is now also made to FIG. 3, which is an exemplary method of classifying an examined user according to safe activity indicative and/or threat indicative communication patterns which are identified in a plurality of multisessions with a plurality of different users, optionally minor users, according to some embodiments of the present invention. First, as shown at 301, a plurality of multisessions between the examined user and a plurality of interacted users are received and optionally documented as or in a plurality of records, for example in the repository 103 by the monitoring unit 104. Each multisession is held in a plurality of occasions between the examined user and another of the interacted users. Optionally, each documented multisession contains the contextual data. Optionally, each documented multisession, for example a multisession record, describes one or more contextual characteristics of communication occasions of the multisession, for example the occasion time, the number of participants in the communication occasion and the like. Optionally, each documented multisession include one or more chat scripts, automatically generated conversation transcripts, emails, messages and the like. Optionally, only some of the contextual characteristics of the communication occasions and/or the multisession are acquired. For example, a monitored multisession may be occasions of interactions, such instant messaging and avatar chatting events in which the examined user interacts with a certain user, such as a child A, in one or more virtual environments. For instance, a first monitored multisession may be of occasions in which the examined user interacts with child A, whose age is not clear and a second monitored multisession may be used child B. The monitored multisessions may be of occasions in a common period, such as a day or a week, for example substantially simultaneously.

As shown at 302, the multisessions are analyzed, separately and/or together, so as to identify one or more contextual data of the multisessions. As used herein, contextual analysis means involving, or depending on a context of values derived from one or more multisessions and not from the analysis of the verbal or linguistic meaning of the content of the these multisessions, for example routing data, metadata, and/or information extracted according to the communicating users, for example personal information and/or demographic information. The data used in the contextual analysis is referred to herein as contextual data. Optionally, the analysis may be of contextual characteristics of the multisessions. In such an embodiment, no content analysis is held so that the computational complexity is relatively low and trials to manipulate the content in a manner that a content analysis does not detect threat indicative communication patterns are doomed to fail as the analysis is not based on content. Alternatively, the data may be content related data and the analysis is of the content of the multisessions, for example of the words, phrases, and/or graphics used in the interactions between the examined user and the interacted users. Optionally, the analysis may be of a combination of content and contextual analyses of the multisessions.

Optionally, the contextual and/or content characteristics are extracted in a preliminary stage. Each multisession is optionally processed by the analysis module 106. Typically, the context may provide sufficient evidence for the needed classification of users. Optionally, the content characteristics may be extracted by analyzing, optionally separately, each multisession and identifying predefined content. Optionally, the contextual characteristics of the multisession are extracted by an analysis of the profile of the examined user and/or interacted user, an analysis of the difference between the profiles of the examined user and the interacted user, and/or an analysis of the home page of the users. Optionally, the preliminary stage includes preprocessing actions, such as generating a log based on the multisession content and/or characteristics.

Optionally, the contextual analysis includes identifying communication operations and reactions of the interacted user to the examined user, for example a rejection of a communication trial or a friendship request of the examined user, such as an invitation to connect, an acceptance of such a communication trial, a blocking of messages from the examined user, disregarding communication trials of examined user and the like. Optionally, the contextual analysis includes relationship analysis, building a graph that depicts the relationship between the interacted user and other interacted users which are in communication with the examined user.

Optionally, the content analysis includes identifying the type of the relationship which is related to the multisession, for example romantic, friendly, related to a certain hobby, such as sport related to a certain fan club, and/or related to a group, such as a class. Such a content analysis may be performed in known text analysis and matching methods.

Now, as shown at 303, one or more patterns are identified by analysis that combines contextual and/or content characteristics from a number of multisessions in which the examined user takes part, namely based on the examined user relationships with a number of interacted users. Optionally, rules or records defining the communication patterns are stored in the system 100, for example in a pattern table, map, and/or any other dataset. Optionally, information documented in one multisession is combined with information documented in one or more other multisessions. In such a manner, a threat indicative communication pattern, a safe activity indicative communication pattern, a risk avoiding communication pattern and/or a risk taking communication pattern is detected based on a combination of data from different users. Such an analysis may be referred to herein as a combined analysis, as shown at 303. In a simple example, the parameters of a multisession with Child A do not provide sufficient information for classifying an alert. However, while interacting with Child-B new indications are provided by the analysis of different interactions.

The combined analysis, which is based on data taken from a number of different multisessions, allows classifying and/or detecting examined users which have a serial or a systematic communication pattern with a number of interacted users. Optionally, the analysis allows detecting a number of communication patterns. In such an embodiment, each pattern may be scored, for example receiving a negative score and/or a positive score for reflecting the weight this pattern should impose on the assessment of the examined user. Optionally, the scores facilitate giving more weight to some characteristics while reducing the effect of others. For example, the fact that one or more children have communicate with the examined user may be estimated as, by itself, not reducing the risk reflected therefrom and therefore receives a low or a null score. However, the fact that one or more children have rejected communication trials, such as friendship requests, of the examined user may be estimated as, by itself, increasing the risk reflected from the examined user and therefore receives a high negative score.

The combined analysis is optionally based on the relationship between the interacted users as reflected from a number of multisessions. In such an embodiment, a difference between the relationships of a number of interacted users may determine the presence and/or absence of a threat indicative communication pattern. For example, if the examined user is rejected by unrelated interacted users, he receives a negative score. However, if the examined user is rejected by an interacted user related to a non rejecting interacted user a negative score is not received or received with a smaller negative value. The assumption is that since the interacted users, optionally children, are linked, it is logical to assume that the examined user relates to their social cycle in real life. In this case, a positive indication of child-to-child interaction implies that this threat degree is reduced as it is based on an existing acquaintanceship.

Reference is now made to a number of exemplary threat indicative communication patterns which may be identified during the combined analysis:
1. A plurality of communication rejections and/or communication malicious reporting—as described above, the analysis of a plurality of multisessions allows identifying a plurality of communication refusals, such as friend request rejections, unanswered communications, blocking contact events, spam/scam/fraud/misuse reports and the like. Optionally, such a pattern is identified is more than a predefined number of interacted users have rejected the examined user. For example, a pattern may be defined as follows:
   Examined user X approaches a plurality users in a children group age where over Z1% of the interacted users denied X requests, over Z2% of the interacted users blocked X, and/or over Z3% of the interacted users reported X's communication as misusing/spamming/scamming user.
2. A plurality of interactions with isolated users—usually, users, such as children, make friends from defined groups of people, such as a class, a lesson, a course, a group of common interest, such as a fan club, a holiday resort, a summer camp and the like. In such defined groups, usually three or more users are connected to one another via social network sites and/or games. For example, it is likely that in a class a child has two or more friends which are connected to one another. When the examined user occasionally interacts with a certain number of unconnected users, there is a threat that this examined user chose them based on a reason which is other than a common interest and/or activity, for example for satisfying pedophilic needs and/or for child exploitation. Such a pattern may be defined as follows: Examined user X approaches a plurality of users Q1-Qi where Less than Z1% of the plurality of users are connected to one another.
3. A similarity to a banned user (masquerading)—when the multisessions of the examined user are indicative of a similarity to a previously banned user, based on similar friends, IP address, MAC address and/or any combination thereof, the user is marked as a threat.
4. A systematic involvement in meaningful communication relationships with children—as described above, the analysis of multisessions may include identifying the type of each multisession. In such a manner, an involvement in a plurality of highly meaningful relationships with children during a common period may be identified as a threat indicative pattern. In such a manner, an involvement in a plurality of romantic relationships may be discovered, for example the involvement in 2, 3, 4, 10 or even more multisessions in which the examined user used phrases such as love you or phrases with sexual insinuations. The involvement in more than one romantic relationship is indicative of a pedophilic pattern in which the pedophile manages romantic relationships with a plurality of victims.
5. A plurality of relations having similarity to various pedophilic communication stages—optionally, the content analysis is performed to discover various pedophilic communication stages, for example as described in International Patent Application PCT/M2010/050329 filed 26 Jan. 2010, which is incorporated herein by reference.
6. Routing information—as described above the contextual analysis may be used to extract routing data and Meta data. This information may be used for detecting suspicious routing behavior, for example using one or more proxy servers to conceal internet protocol (IP) address. The involvement routing patterns which are used to conceal identity is not a common communication pattern of an innocent user and therefore indicative of a pedophilic pattern in which the pedophile tries to hide the relationships with a plurality of victims.

According to some embodiments of the present invention, the combined analysis allows detecting other unsafe communication behavior patterns which indicate that while the examined user is not necessarily malicious, a negative threat may be formed. Such common threats are bullying, where a child is subject to pressure, violence or isolation, typically by his colleagues, and ganging, where the child belongs to a “secret-sharing” group, which has some negative common denominator, such as drug dealing, or some vandal oriented group. Different patterns of behavior need to be detected for these threats, as the communication patterns are completely different. It can be one or more of the following:
1. A participation in an online group of children. If the examined user shares some secret with the group, builds unique slang, and discusses dangers, it is likely to be a risky pattern. Such a pattern may be defined as follows: When the examined user have at least K1 interacted users which are connected to one another (gang G), and secrecy content is observed, as well as threats from authorities or parents with likelihood bigger than L K, and the user within the gang G communicate closely, for example at least twice a day, Additionally, if negative association is observed to this coding, and optionally, this coding scheme does not exist while the examined user communicates outside of G and optionally, this behavior is observed over a time period greater than a W weeks (for example more than 3 weeks).
2. An isolated child (bullying) pattern—in this case a child is put under pressure either in order to achieve a target, or simply for bullying reasons. The child receives multiple negative messages from a group G of people, some of which have typically been in friendly terms with the child. Then, a content analysis of the multisessions identifies that some of them includes malicious content, such as threats. If a certain threshold is crossed, for example the severity and/or the frequency of the malicious content in the multisessions, than unsafe communication behavior patterns, which are threat indicative, are detected.

According to some embodiments of the present invention, the combined analysis allows detecting safe activity communication patterns which indicates that the examined user is not malicious. In such embodiment, the classification is based on a score given to the examined user based on a combination of the safe activity communication patterns and the threat indicative communication patterns. Such safe activity, reassuring communication patterns may be one or more of the following:
1. A child avoiding interaction with known malicious users. Although the child is occasionally approached by strangers, some of whom are potentially recognized malicious users, the child turns these requests down. In a similar pattern, for more mature children, the child selectively accepts approaches from strangers, however if they turn into bad relations, the child stops these interactions.

The analysis allows, as shown at 304, classifying the examined user and/or the multisessions in which the examined user participates according to a combination of data, such as contextual data, from the plurality of communication patterns, such as threat indicative communication patterns. As shown at 305, the process depicted in FIG. 3 may be repeated a plurality of times for a plurality of different examined users.

According to some embodiments of the present invention, the combined analysis allows detecting risk taking communication patterns which indicate that the examined user tends to take risks and communicates with suspicious users or an opposite risk avoiding communication patterns which indicate that the examined user tends to avoid risks. In such embodiment, the classification is used to classify a child having a risk taking communication patterns. Such risk taking and/or risk avoiding communication patterns may be one or more of the following:
1. A tendency to communicate with strangers. When the multisessions are indicative of that the examined user receives and approves a plurality of communication requests from strangers, and responds and interacts with these strangers. A stranger may be defined as a user with which the examined user has no common friends or a limited number of common friends, or based on simple content analysis, such as textual content analysis of introduction session.
2. A tendency to avoid risks—when the multisessions are indicative of that the examined user avoids relationships with a plurality of strangers. Such a pattern may be defined as follows: the examined user is approached by at least K strangers within a time window T w and the examined user does not communicate therewith, or stops this communication rather shortly within D days after they were initiated.
3. A child with over exposure to adults: Children, who publish their private information incorrectly in some web-sites, are exposed to more access by strangers. A child who is constantly accessed by strangers is estimated as at higher risk.

The classification may be used, as shown at 306, to output a notification which is indicative of the classification, for example an alert, an alarm and/or a report, which is sent to one or more guardians, for example all of the parents of all of the minor user with which the examined user in contact, one or more enforcement agents, and/or to the system operator, allowing him to take measures against the examined users and/or notifying enforcement agents and/or guardians. Optionally, notifications are sent according to a user profile in which the guardians or the user can define which threats worries them more and/or when to provide them with a notification. Optionally, the notification is forwarded to a managing entity of a virtual environment, such as a managing module of social networking site and/or game. In such a manner, the profile of the examined user may be changed and/or notifications may be sent to members of his contact list automatically.

When the detected pattern is a communication pattern which indicates that the examined user is a child that tends to take risks, that the examined user is a child that communicates with suspicious users, and/or a child that tends to avoid risks, a notification may be sent to the guardians of the examined user and/or to the examined user itself. Optionally, the examined user receives a behavioral score based on the matched pattern. In such an embodiment, the score may be constantly updated according to the user behavior.

According to some embodiments of the present invention, users are marked as risk taking users and/or as risk avoiding users who have safe communication habits. Optionally, this is done based on identifying threat and safety activity indicative patterns. As described above, the analysis of the multisessions allows detecting threat and safety activity indicative patterns. In such an embodiment, the examined users may be positively and/or negatively scored. Such scoring may be used for classifying the risk affinity of users who interact therewith.

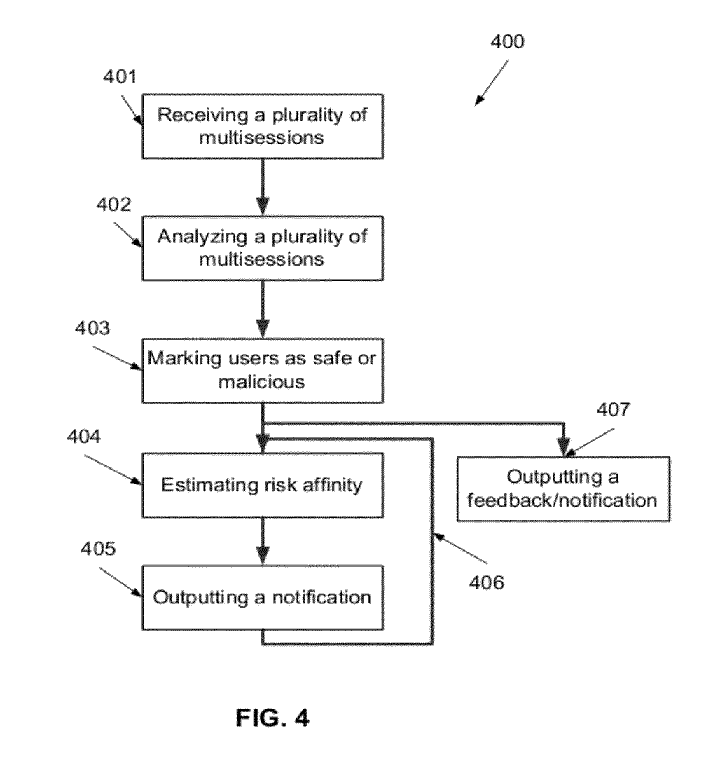

For example FIG. 4 depicts a flowchart of method of classifying the risk affinity of users and/or providing a positive and/or negative feedback to a user pertaining to a communication in a virtual environment, according to some embodiments of the present invention. First, as shown at 401 and 402, multisessions among a plurality of users are received and analyzed, for example as described above in relation to 301 and 302 of FIG. 3. Now, as shown at 403, users or multisessions they participate in are scored, tagged or marked as safe or malicious users, for example according to a match with the aforementioned threat and safety activity indicative patterns.
In another embodiment of the current invention, at this stage 403 the communication pattern is matched, for the communication types and parameters of the examined user, and as a result, specific relationships (or multisessions) are classified as safe or dangerous.

The marking of users and/or the multisessions as safe or malicious allows, as shown at 404, estimating the risk affinity of a user according to the existence, the number, and/or the percentage of malicious users he or she communicates with. Optionally, the user is scored or marked with according to a risk affinity value. This allows, as shown at 405, outputting a notification which is indicative of his risk affinity. For example, a notification may be forwarded to the user and/or to his guardians, as shown at 407. As shown at 406, this process may be repeated for a plurality of users, for example some or all of participates of a virtual environment such as a social networking site and/or a multiplayer game, or across several virtual environments.

Additionally or alternately, as shown at 407, a positive and/or negative feedback are presented to the user and/or to the guardian based on the other users the user chooses to communicate with. When the examined user, U1, chooses to communicate with another user, U2, who is marked as a malicious user, for example as he has been identified as having one or more threat indicative communication patterns, the examined user U1 is marked as under threat. In one embodiment, or based on the user profile the user (or his guardian) may receive a warning, a reduction in his score and/or a negative feedback, such as a disappointing or sad smiley face. Even if this warning has not been issued, and if during the multisession analysis it is observed that U1 has terminated the relations with U2, the user (or his guardian) U1 may receive a positive feedback for avoiding risks.
In another sample case, when the user U1 chooses to communicate with another user U3, who is marked as a safe user, for example as he has been identified as having one or more safe activity indicative communication patterns, the user receives a positive feedback, such as a smiling emoticon and/or an increase in his score.

Reference is now made to an exemplary network-based algorithm which is used for detection threats, such as users with threat indicative communication patterns, according to some embodiments of the present invention. The following describes a high level exemplary implementation of the algorithm. The algorithm assumes that a list of threat indicative communication patterns is provided. Sample threat indicative communication patterns, which may be used to demonstrate malicious systematic patterns, are described above. The algorithm is composed of two stages, pre-processing, where initial parameters and patterns are compiled and analyzed, and then an on-going detection service is provided.

During the pre-processing, in addition to the list of optional threat indicative communication patterns, the system requires, for each examined user, a dataset which maps who are the interacted users which have been involved in multisessions with the examined user and optionally the relationship between them (communicating, rejected communication, or not connected at all, and the like) and optionally one or more multisession records which logs communication, such as chats, or summaries of chats, previously held communication occasions for each multisession.

Optionally, the evaluating of an examined user is an ongoing process such that an examined user profile may be constantly, periodically, and/or randomly updated according to a communication data update which describes the communication that occurred since the multisession records were last updated. The multisession records now include updated list of interacting users, updated list of relations among the interacting users, and new logs of chats and/or summaries thereof.

It should be noted that the systems and methods described above may be used for classifying different users according to different threat indicative communication patterns, such as, scam or fraud related communication patterns, unfaithful communication patterns, sex crime communication patterns, and/or serial killer communication patterns. The same is true for safe activity indicative communication patterns, risk taking communication patterns, and/or risk avoiding communication patterns. The systems and methods may be used for detecting inappropriate behavior in dating sites or among any children group.

In the end of the preprocessing, the system generates a list of threat indicative communication patterns which have been identified as conducted by the examined users and associate it therewith. Optionally, the examined multisessions and examined users are scored accordingly. Optionally, examined multisessions and users may be marked, for example scored, as valid non-malicious multisessions/users. This process is optionally repeated to a group of examined users, for example some or all of the subscribers of a social networking website and/or game. In such a manner, a report of examined users and multisessions which is suspect for malicious communication behavior is formed and optionally forwarded to the users, the guardians, and/or the system operators. Optionally, the process also generates a list of well-behaved examined children. These children (or their guardians) may receive an indication for their good behavior, which allows for an educational dialogue between the guardian and the child.

The scoring and/or marking of examined multisessions as non-malicious users and/or multisessions or malicious users and/or multisessions allows evaluating the safety of the threat indicative communication patterns of each interacted user or multisessions in which she or he participates. While a user who manages one or more multisessions with malicious users is evaluated as a high risk user who takes risks in social networking sites and/or games a user who manages such multisessions with non-malicious users is evaluated as a low risk user who safely use the social networking sites and/or games.

In exemplary embodiments, the computation of the algorithm is performed as follows:

### Stage A:

### Pre-Processing:

1. Constructing an initial communication graph, denoted herein as G, from the raw data. G maps the relationships between the examined user and users who interact therewith.
2. Providing a list of potential threat indicative communication patterns and/or safe activity indicative communication patterns
3. Identifying matching communication patterns based on the initial data as follows:
Construct an empty relations graph, G.
For each participant in the network, P, compute the following:
   Add P to the graph G;
   Add P's profile data, for example from the user profile record, social network data, and/or a guardian's input, such as a questionnaire;
   Generate identity for P;
   For each of P's friends, Q, do as follows:
      Add Q to the graph G;
      Extract the needed identity for Q;
      For each friendship request mark the originator, including time and date.
      If P denied relations with Q, (blocked, marked as spam, etc') mark the edge Qᵢ→P appropriately.
   For each multisession, for example interaction-chat summary between P and Q:
      Split to occasions, such as conversations, (for example based on time-date)
      For each occasion—compute the conversation meta-data—parameters:
         Occasions time-of-day; Occasions duration; initiator
         (optional content summary)—word spot for defined patterns;
         (optional) Extract lingual-identity parameters based on summary.
         (optional content analysis) Extract personality-identity parameters
   For each pre-defined threat-forming pattern, and safe activity indicative communication pattern—compile the predefined pattern, T, and its parameters into stored procedure PAT; The output of applying the stored procedure contains at least one of the following two lists:
      Relationship list: each relationship in the list matches the pattern;
      Participant list and participants' roles: each participant in this list matches the pattern
      Each list is associated with an explanation, EXP, which is based on the pattern parameters and the computed values.
   Apply all of the pattern procedures PAT to the graph G; for each procedure generate the relevant lists, R_list (relations) and P_list (participants), and the explanation after parameters computation EXP_list. The P_list contains “good” and “bad” people. “Good” people are those that matched a positive pattern, hence they managed to avoid predators; bad people are the predators.
      The outputs of stage A are initial lists R_list, P_list and their explanations, EXP_list.
      In Addition, the relationship graph G is stored.

### Stage B:

### Ongoing Processing:

### Inputs:

Preprocessed relations graph, G.
Pre-compiled pattern list to look for PAT_list.
Initial R_list and P_list and explanation list EXP_list.
Delta of new subscribers (users) D_SUB.
Delta of relationship lists (requested, accepted, rejected) D_REL.
(Optional) chat log summaries since last computation LOG_SUMM.

### Outputs:

Updated lists:
   R-lists—relationship lists, and their explanations. Why these relations prove a pattern.
   P-list (good, bad)—participant lists; good participants (those that avoided attacks) and bad participants (predators) and the relevant explanations.
   EXP_list—explanation of the various parameters for the matched parameters.

### Side-Effect:

Updated relation graph G.
   The aforementioned stages allow computing the following:
For each participant P in the new data D_SUB—add P and its parameters to the input graph G;
For each relation in the new relation data D_REL update edges between P and Q (forming new edges, or marking edges—requested, accepted, denied, etc')
For each participant, P, in input graph G compute the following:
   Update P's profile data (if changed in social network data);
   Generate new P's identity;
   For each of P's friends in G, Q:
      Update Q relations with P based on D_REL;
      Updated identity for Q;
      For each friendship request mark the originator, including time and date.
   (Optional) for each chat summary between P and Q in D_SUMM:
      Split to occasions (based on time-date)
      For each occasion—compute the occasion meta-data—parameters:
         Occasion time-of-day; conversation duration; initiator
         (Optional) word spot for defined patterns;
         (Optional) extract lingual-identity parameters.
         (optional) Extract personality-identity parameters
   Compare and unify P's identity with identity database; if P is in the R_list(bad) unify P with the R_list(<bad_person>) identity. Add P to list.
   Apply all of the pattern procedures PAT in PAT-list to the graph G; for each procedure PAT generate the relevant lists, R_list (relations) and P_list (participants), and the explanation after parameters computation EXP.

It is expected that during the life of a patent maturing from this application many relevant systems and methods will be developed and the scope of the term computing units, servers, and networks is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, an and the include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all of the possible sub ranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all of the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of monitoring communication in at least one virtual environment, comprising:
providing a plurality of multisessions each held in a plurality of occasions between the examined user and another one of plurality of users;
indentifying at least one communication pattern of said examined user by contextual data extracted from said plurality of multisessions;
classifying at least one of said plurality of multisessions and said examined user according to said at least one communication pattern; and
outputting a notification indicative of said classification.

2. The method of claim 1, wherein said identifying comprises analyzing said plurality of multisessions to identify a plurality of communication characteristics and indentifying said at least one communication pattern according to a combination of said plurality of communication characteristics.

3. The method of claim 1, wherein said contextual data comprises a number of rejections of communication trails of said examined user by one of said plurality of users.

4. The method of claim 1, wherein said contextual data comprises a dataset mapping relationships among said plurality of users and said indentifying said at least one communication pattern according to said dataset.

5. The method of claim 1, wherein said identifying comprising identifying a progress in pre-defined criminological communication scenario in at least two of said plurality of multisessions; said indentifying being performed according to said progress.

6. The method of claim 1, wherein said identifying comprising identifying at least one of a presence and an absence of a common characteristic among said plurality of users; said indentifying being performed according to at least one of said presence and said absence.

7. The method of claim 1, wherein said identifying comprising identifying a type of a relationship between said examined user and said one of said plurality of users in at least two of said plurality of multisessions and said indentifying said at least one communication pattern by matching said types.

8. The method of claim 1, wherein said identifying comprising matching a first user profile of said examined user with a second user profile of a previously classified examined user and said indentifying said at least one communication pattern according to said match.

9. The method of claim 1, wherein said analyzing contextual data comprises a plurality of contextual communication characteristics of said plurality of multisessions.

10. The method of claim 1, wherein said indentifying comprising combining a first output of contextual analysis of said plurality of multisessions with a second output of a content analysis of said plurality of multisessions.

11. The method of claim 1, wherein said indentifying comprising detecting usage in one or more proxy servers by said examined user; said indentifying being performed according to said usage.

12. The method of claim 1, wherein said identifying is performed without a content analysis of said plurality of multisessions.

13. The method of claim 1, wherein said providing comprises monitoring said plurality of multisessions in real time; wherein said outputting is performed in real time.

14. (canceled)

15. The method of claim 1, wherein said at least one communication pattern is a safe activity indicative communication pattern.

16. The method of claim 1, wherein said at least one communication pattern is a threat indicative communication pattern, said outputting comprises alarming a member of a group consisting of: at least one guardian associated with at least one of said plurality of users, an administrator of the at least one virtual environment, and at least one of said plurality of users.

17. The method of claim 1, wherein said at least one communication pattern is a risk taking communication pattern, said outputting comprises a member of a group consisting of: alarming at least one guardian associated with said examined user and presenting a feedback to said examined user.

18. A system of monitoring communication in at least one virtual environment, comprising:
a repository which stores a plurality of multisessions each held in a plurality of occasions between the examined user and another one of plurality of users;
an analysis unit which analyzes said plurality of multisessions to identify at least one communication pattern and classifies at least one of said plurality of multisessions and said examined user according to said at least one communication pattern; and
an output unit which outputs a notification pertaining to said classification.

19. The system of claim 18, further comprising a monitoring unit which monitors the at least one virtual environment to document said plurality of multisessions in said repository.

20-22. (canceled)

23. A method of classifying a plurality of examined users in at least one virtual environment, comprising:
monitoring a plurality of multisessions each held in a plurality of occasions between at least two of plurality of examined users of the at least one virtual environment;
indentifying at least one safe activity indicative communication pattern of a first group of said plurality of examined users and indentifying at least one threat indicative communication pattern of a second group of said plurality of examined users;
classifying at least one member of said first and second groups according to said identification; and
outputting a notification indicative of said classification.

24. The method of claim 23, wherein said identifying is performed by combining data extracted from said plurality of multisessions.

25. (canceled)
